(19) United States
(12) Patent Application Publication
(10) Pub. No.: US 2026/0117651 A1
(43) Pub. Date: Apr. 30, 2026

(54) FORMATION ELASTIC PROPERTY ESTIMATION OF A GEOLOGICAL FORMATION USING DRILLING DATA

(71) Applicant: Halliburton Energy Services, Inc., Houston, TX (US)

(72) Inventors: Bei Li, Singapore (SG); Xusong Wang, Singapore (SG); Robert Warner, Conroe, TX (US); Ning Tu, Singapore (SG); Xiang Wu, Houston, TX (US)

(21) Appl. No.: 19/361,145

(22) Filed: Oct. 17, 2025

Related U.S. Application Data
(60) Provisional application No. 63/713,819, filed on Oct. 30, 2024.

(51) Int. Cl. E21B 49/00; E21B 45/00; G01V 1/50

(52) U.S. Cl. CPC E21B 49/003; E21B 45/00; G01V 1/50; E21B 2200/20; E21B 2200/22; G01V 2210/74

(57) ABSTRACT

A method for estimating elasticity of a formation comprises determining, via a neural network, mapping parameters based on respective drill bit vibrations for each of a plurality of respective frequency bands and a rate of penetration included in drilling data; and estimating, by a physics-based model, the elasticity of the formation based on stress and strain representatives mapped via the mapping parameters from the respective drill bit vibrations and the rate of penetration of a drill bit during a drilling run in the formation.

### TECHNICAL FIELD

Some implementations relate to determining elastic properties of a geological formation. More specifically, some implementations relate to generative-artificial-intelligence-assisted formation elastic property estimation. Some implementations control well operations based on those elastic properties.

### BACKGROUND

Determining elastic properties of formations in a geographic area may require reference data (such as logging data) from previously drilled wells in that geographic area. When drilling wells in geographic areas for which there is no reference data, determining elastic formation properties may be inaccurate or otherwise impossible.

### BRIEF DESCRIPTION OF THE DRAWINGS

Implementations of the disclosure may be better understood by referencing the accompanying drawings.

FIG. 1 is a diagram illustrating a neural network (NN) structure, according to some implementations.

FIG. 2 is a diagram showing operations for an AI-assisted formation elastic property estimation using drilling data, according to some implementations.

FIG. 3 depicts a diagram showing a wireline system, according to some implementations.

FIG. 4 is a schematic diagram of a drilling rig system, according to some implementations.

FIG. 5 is a flow diagram showing operations for determining formation elasticity, according to some implementations.

FIG. 6 is a block diagram illustrating a computer system that may be utilized with some implementations, according to some implementations.

### DESCRIPTION OF IMPLEMENTATIONS

The description that follows may include example systems, methods, techniques, and program flows that embody implementations of the disclosure. However, this disclosure may be practiced without these specific details. For clarity, some well-known instruction instances, protocols, structures, and techniques may not be shown in detail.

### Overview

Traditional methods for estimating formation elasticity apply physics-based models to drilling data to estimate the elasticity of formations. The drilling data may include dill bit vibrations and rates of penetration (ROP) for one or more drilling runs at a geographic location. Traditional methods may apply Young's Modulus to estimate stress and Poisson's Ratio to estimate strain on the rock based on the drilling data. Based on the estimated stress and strain, Hooke's law enables inversion of elastic properties of the formation. Using Hooke's Law, the input stress and strain for elastic property inversion may be linearly mapped from the drill-bit vibrations and the ROP. However, this linear mapping may be ineffective if used in different drilling processes that involve different geographic locations, different drilling equipment (such as drill bits), different drilling speeds, and/or other differences. For example, as aspects of a drilling process change, selecting frequency-bands for the drill-bit vibrations may become challenging. Consequently, determining mapping parameters across different wells in different geographical regions and/or different drilling processes also may become difficult.

Some implementations overcome these challenges by providing a new method for estimating formation elasticity. Some implementations determine a normalized Young's Modulus by mapping stress and strain representatives from different frequency-band drill-bit vibrations and the associated ROPs. The mapping parameters may be used as constant biases for determining the normalized Young's Modulus. The mapping parameters may be obtained from a trained neural network (NN). Input to the trained NN may be a 2D probabilistic distribution of any given frequency-band for drill-bit vibrations and the ROP.

Some implementations use all frequency bands above 150 Hz independently to provide estimations of the normalized Young's Modulus. In some implementations, only two biases require calibration to estimate formation elasticity for any drilling process. Because the mapping parameters are provided by a trained NN, the data-driven bias calibration eliminates the need for reference logs after the NN is trained. The data-driven bias calibration enables generalizability across different drilling processes such as those in different geographical regions.

### Example Implementations

Some implementations utilize a bit-rock interaction model in estimating formation elasticity. The bit-rock interaction model may linearly map the drilling vibrations into stress and rate of penetration (ROP) into strain, along tangential (y) and axial (z) directions. Representing the general proportional relationship by scales and biases, 2D Hooke's law for normal stress and strain may be rearranged as follows:

$$[ \begin{matrix}A \cdot VibeY + {A}_{0} \\ B \cdot VibeZ + {B}_{0}\end{matrix} ] = [ \begin{matrix}\frac{E}{( 1 - 2 v ) ( 1 + v )} & \frac{Ev}{( 1 - 2 v ) ( 1 + v )} \\ \frac{2 Ev}{( 1 - 2 v ) ( 1 + v )} & \frac{E ( 1 - v )}{( 1 - 2 v ) ( 1 + v )}\end{matrix} ] [ \begin{matrix}C \cdot ROP + {C}_{0} \\ D \cdot ROP + {D}_{0}\end{matrix} ] , \qquad ( 1 )$$

where E and ν are the Young's modulus and Poisson's ratio, respectively; A, B, C, D and A₀, B₀, C₀, D₀ are the scales and biases to linearly map the drilling data (VibeY/Z and ROP) into corresponding stress and strain representatives. These mapping parameters, including both scales and biases, may be calibrated first before using them to predict the E and ν based on equation 1.

Due to the relative variation in ν (Poisson's ratio) being much smaller than E (Young's modulus), the bit-rock interaction model may use a constant ν to estimate a reliable E using measurements along both y and z directions. This reduces equation 1 into:

$$VibeY + {b}_{A}^{Y} = ( ROP + {b}_{R}^{Y} ) ( {EN}_{Y} ) \qquad ( 2 a )$$

$$VibeZ + {b}_{A}^{Z} = ( ROP + {b}_{R}^{Z} ) ( {EN}_{Z} ) \qquad ( 2 b )$$

$$where {b}_{A}^{Y} = \frac{{A}_{0}}{A} , {b}_{A}^{Z} = \frac{{B}_{0}}{B} , {b}_{R}^{Y} = \frac{{m}_{1} {C}_{0} + {m}_{2} {D}_{0}}{{m}_{1} C + {m}_{2} D} , {b}_{R}^{Z} = \frac{{m}_{3} {C}_{0} + {m}_{4} {D}_{0}}{{m}_{3} C + {m}_{4} D} , {N}_{Y} = \frac{{m}_{1} C + {m}_{2} D}{A} , and {N}_{Z} = \frac{{m}_{3} C + {m}_{4} D}{B} . {m}_{1}$$

to m₄ are constants determined by the assumed constant ν, such as ν=0.25.

According to equations 2a and 2b, the constant-scaled E (EN_{Y} or EN_{Z}) may be estimated by a constant-biased VibeY/Z divided by a constant-biased ROP as follows:

$${EN}_{Y / Z} = \frac{VibeY / Z + {b}_{A}^{Y / Z}}{ROP + {b}_{R}^{Y / Z}} \qquad ( 3 )$$

In equation 3, the mapping parameters required for calibration reduce from 8 (A-D, A₀-D₀) (see equation 1) to

$$2 ( {b}_{A}^{Y / Z} , {b}_{R}^{Y / Z} )$$

(see equation 3) for one realization of (relative) E estimation. With overlapping reference E and the drilling data (such as logging data), the optimal mapping parameters can be obtained by maximizing the R² value between the normalized estimated E and the normalized reference E:

$$( {\hat{b}}_{A}^{Y / Z} , {\hat{b}}_{R}^{Y / Z} ) = {max}_{( {b}_{A}^{Y / Z} , {b}_{R}^{Y / Z} )} {R}^{2} ( {N}_{{r}_{e s t}} {E}_{e s t} , {N}_{{r}_{ref}} {E}_{ref} ) where ( {\hat{b}}_{A}^{Y / Z} , {\hat{b}}_{R}^{Y / Z} ) \qquad ( 4 )$$

represent the optimal biases; Nᵣ_{ₑₛₜ} and Nᵣ_{_{ref}} denote the root-mean-square normalizers for the estimated E (Eₑₛₜ=E_{ref}N_{Y/Z}) and the reference E (E_{ref}), respectively. A simple 2D grid search may be used to solve equation 4.

Although the calibrated biases obtained from equation 4 may show some level of transferability across runs in the same geographic region, those calibrated biases may fail when applied to a different geographic region. For example, using biases calibrated from Brazil may fail when used in the Gulf of Mexico. In addition, the calibration may be based on a fixed frequency range where the VibeY/Z sequences are originally derived, thus unable to transfer across different frequency bands even for the same drilling run. Such transferability limitations may be related to the marked differences in the statistics of the drilling data between the calibration and prediction, when across geographic regions and/or frequency bands. Hence, statistics of the drilling data may determine the corresponding biases.

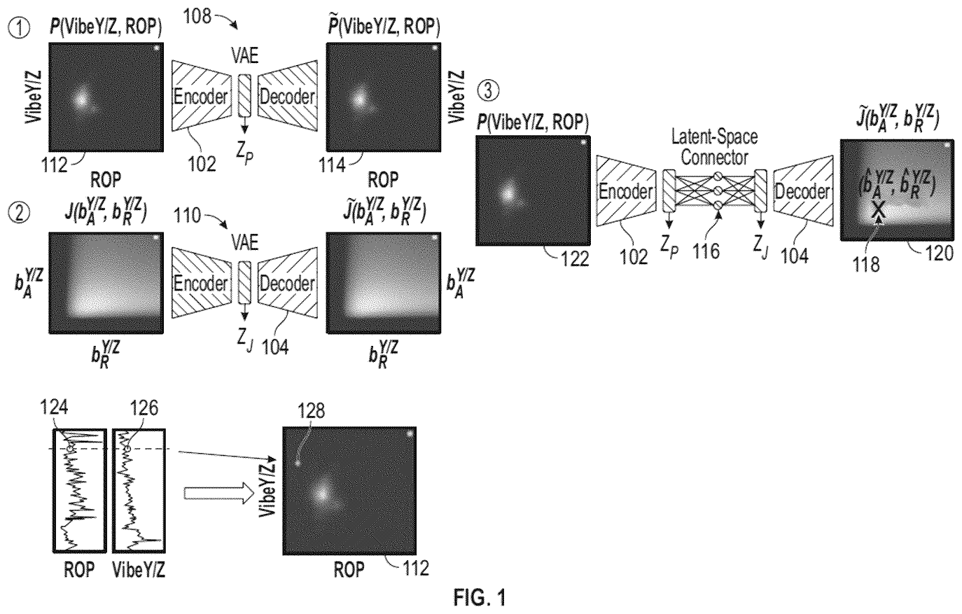

Some implementations include a neural network (NN) structure based on generative artificial intelligence (AI) (such as variational autoencoders (VAEs)) for inferring the mapping biases from statistics of the drilling data. FIG. 1 is a diagram illustrating an NN structure, according to some implementations. The NN structure includes an input encoder 102, an output decoder 104, and latent space connector 116. Any of the components shown in FIG. 1 may be implemented via any suitable computer technology (such as computer hardware and software). The input encoder 102 and output decoder 104 may be trained independently as part of input and output VAEs (108 and 110), respectively. After the two VAEs (108 and 110) finish training, the latent-space connector 116 may be trained given the fixed input encoder 102 and output decoder 104. An input 112 (such as 64×64 image) into the input encoder 102, denoted as P (Vibe Y/Z, ROP), may be the 2D probabilistic distribution for the given corresponding 1D sequence of the VibeY/Z and ROP. In some implementations, the input 112 is a 64×64 image in which a point 128 indicates an associated ROP value 124 and an associated Vibe Y/Z value 126 from the drilling data. The output 120 (such as a 64×64 image), denoted as

$$J ( {b}_{A}^{Y / Z} , {b}_{R}^{Y / Z} ) ,$$

may include an R² map obtained by a 2D grid search of

$${b}_{A}^{Y / Z} and {b}_{R}^{Y / Z}$$

within proper ranges, according to equation 4 given E_{ref}. The calibrated biases

$$118 ( {\hat{b}}_{A}^{Y / Z} , {\hat{b}}_{R}^{Y / Z} )$$

may be obtained by identifying the

$${b}_{A}^{Y / Z} and {b}_{R}^{Y / Z}$$

corresponding to the maximum R² value in the NN output R² map 120. Zₚ and Zⱼ indicate the latent space vectors, which may be connected by the latent-space-connector 116. Both VAEs (108 and 110) and the latent space connector 116 may be implemented as a basic artificial neural network (ANN) with fully connected layers. The input and output VAEs (108 and 110) may utilize input dimension as 64×64=4096, hidden dimension as 512, and latent dimension as 256. The connector utilizes input dimension as 256, hidden dimension as 64, and latent dimension as 8.

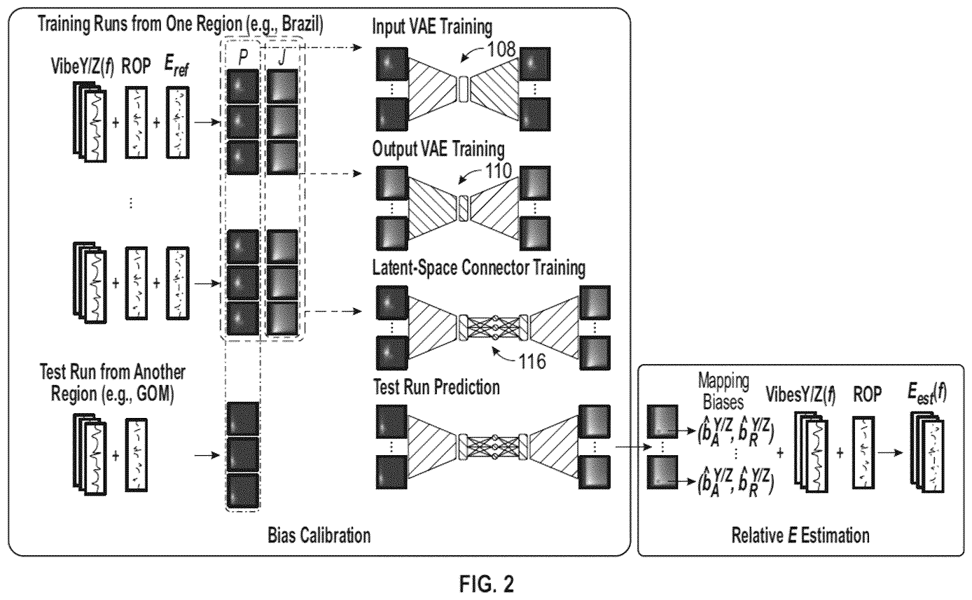

FIG. 2 is a diagram showing operations for an AI-assisted formation elastic property estimation using drilling data, according to some implementations. In FIG. 2, the operations may be described in two parts: a data-driven bias calibration based on a NN structure (such as the NN shown in FIG. 1), and the physics-driven relative E estimation based on equation 3. FIG. 2 shows an implementation that has transferability to different geographic regions. The output VAE 110 and the latent space connector 116 may be trained using P and J generated from training runs solely in one geographic region, where the E_{ref} is available. However, the input VAE 108 may be trained using P generated from both training runs and the test runs in two different geographic regions. Such training strategy enables the trained input VAE 108 to differentiate between different training runs and the test run in the input latent space, which aids the generalization of the whole NN, even though the latent-space connector 116 and the output decoder have never seen the test run data during their training processes. In addition, in each training or test run, multiple VibeY/Z sequences may be generated from various frequency bands (such as frequency bands>150 Hz), denoted as Vibe Y/Z (f). Each Vibe Y/Z (f) combined with the ROP forms the frequency-band-specific input P, and if E_{ref} is available, the corresponding/is also calculated using equation 4. Hence, the trained NN can predict mapping biases for different frequency-bands Vibe Y/Z, leading to multiple independent estimations of the relative E, which allow our method to quantify the uncertainty of the estimation.

In some implementations, the VAE trained on pure input data can suppress non-characteristic “noises” in the input data. Hence, some implementations may enable AI-based “input data orthogonalization.” In some implementations, the VAE trained on pure input data can utilize the testing dataset, as the input VAE training may be irrelevant to the output data or label. Hence, it may be achievable in real application, where the target well/run only has the data input without the output.

In some implementations, the VAE may be trained on pure output data and can make sure the reconstructed R² map is always realistic, which stabilizes the maximizing process for retrieving optimal

$$( {\hat{b}}_{A}^{Y / Z} , {\hat{b}}_{R}^{Y / Z} ) .$$

This may be crucial when moving the NN from a first geographic region to a second geographic region when the NN was trained based on data from first geographic region.

The NN structures of both VAEs and the latent-space connector are not limited to ANN with fully connected layers. Any other types of NN backbones can be utilized, such as Convolutional layers, Fourier Neural Operators, and attention mechanism, etc. Furthermore, the drilling data used in this application are not limited to drill-bit vibrations and ROP. Other downhole and/or surface measurements can also be mapped into stress and strain representatives, such as Torque on bit (TOB), weight on bit (WOB), and roll per minute (RPM), and others.

The NN input may be simplified into 1D vectors including the explicit statistics of the input drilling data sequences, including mean, standard deviation, maximum, minimum, etc. The NN output may be simplified into the vector directly containing the optimal mapping biases. In some implementations, the drill-bit vibrations from frequency bands below 150 Hz can be utilized.

### Example Environment

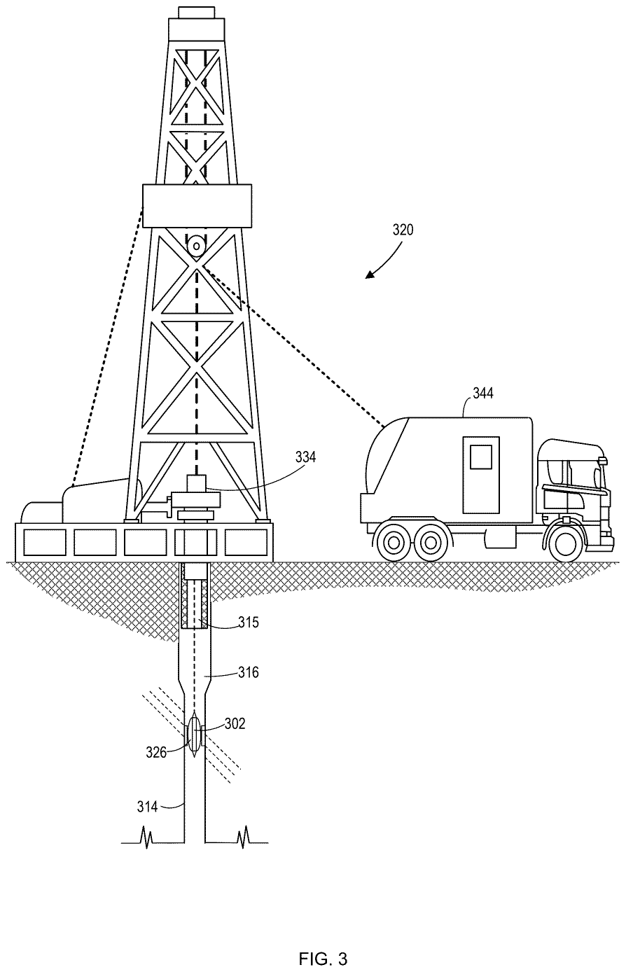

FIG. 3 depicts a diagram showing a wireline system, according to some implementations. As shown, a wireline system 320 may be utilized with a drill string removed from a borehole 314. However, some or all of the drill string may remain in a borehole 314 during logging with the wireline system 320. The wireline system 320 may include one or more logging tools 302 that may be suspended in the borehole 314 by a conveyance 315 (e.g., a cable, slickline, or coiled tubing). The logging tool 302 may be communicatively coupled to the conveyance 315. The conveyance 315 may contain conductors for transporting power to the wireline system 320 and telemetry from the logging tool 326 to a logging facility 344. Alternatively, the conveyance 315 may lack a conductor, as is often the case using slickline or coiled tubing, and the wireline system 320 may contain a control unit 334 that contains memory, one or more batteries, and/or one or more processors for performing operations and storing measurements. Logging data captured or otherwise created by the logging facility 344 may be utilized by any of the components and operations described herein. The logging facility 344 may implement any of the operations for determining elastic properties of formations described herein.

In certain implementations, the control unit 334 may be positioned at the surface, in the borehole (e.g., in the conveyance 315 and/or as part of the logging tool 302) or both (e.g., a portion of the processing may occur downhole and a portion may occur at the surface). The control unit 334 may include a control system or a control algorithm. In certain embodiments, a control system, an algorithm, or a set of machine-readable instructions may cause the control unit 334 to generate and provide an input signal to one or more elements of the logging tool 326, such as the sensors along the logging tool 302. The input signal may cause the sensors to be active or to output signals indicative of sensed properties. The logging facility 344 (shown in FIG. 3 as a truck, although it may be any other structure) may collect measurements from the logging tool 326, and may include computing facilities for controlling, processing, or storing the measurements gathered by the logging tool 302. The computing facilities may be communicatively coupled to the logging tool 302 by way of the conveyance 315 and may operate similarly to the control unit 334. In certain example embodiments, the control unit 334, which may be located in logging tool 302, may perform one or more functions of the computing facility.

The logging tool 302 may include a mandrel and a number of extendible arms coupled to the mandrel. One or more pads may be coupled to each of the extendible arms. Each of the pads may have a surface facing radially outward from the mandrel. Additionally, at least a sensor may be disposed on the surface of each pad. During operation, the extendible arms may be extended outwards to a wall of the borehole to extend the surface of the pads outward against the wall of the borehole. The sensors of the pads of each extendible arm may detect image data to create captured images of the formation surrounding the borehole.

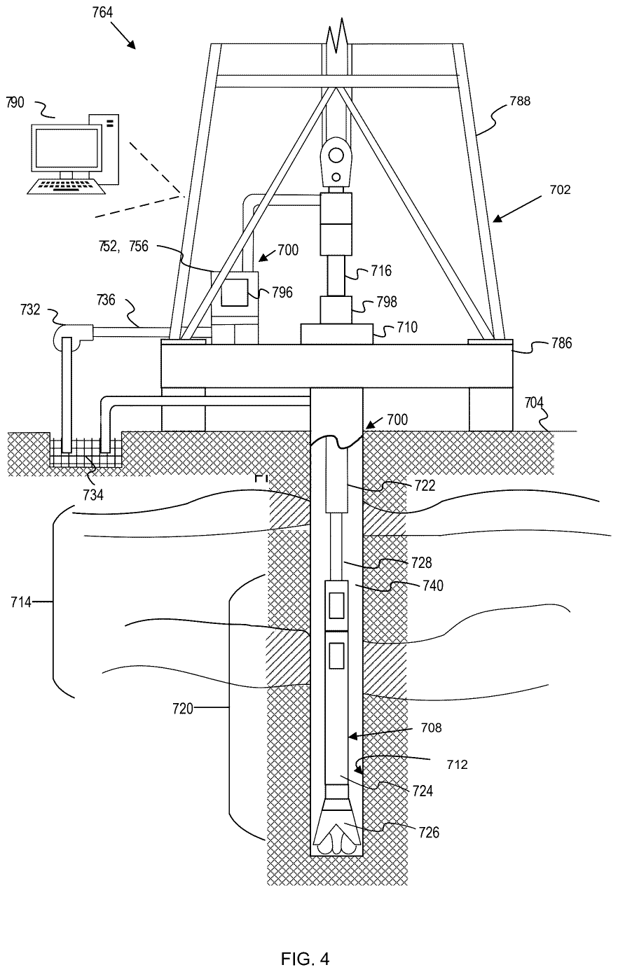

FIG. 4 is a schematic diagram of a drilling rig system, according to some implementations. For example, in FIG. 4 it can be seen how a system 464 may also form a portion of a drilling rig 402 located at the surface 404 of a well 406. Drilling oil and gas wells is commonly carried out using a string of drill pipes connected together so as to form a drilling string 408 that may be lowered through a rotary table 410 into a wellbore or borehole 412. Here a drilling platform 486 may be equipped with a derrick 488 that supports a hoist. A computer system 490 (e.g., similar to the computer system 500) may be communicatively coupled with any measurement devices attached to the system 464 and may be configured to perform any of the operations for generating logging data and/or for determining formation elasticity as described herein.

The drilling rig 402 may thus provide support for the drill string 408. The drill string 408 may operate to penetrate the rotary table 410 for drilling the borehole 412 through subsurface formations 414. The drill string 408 may include a Kelly 416, drill pipe 418, and a bottom hole assembly 420, perhaps located at the lower portion of the drill pipe 418.

The bottom hole assembly 420 may include drill collars 422, a down hole tool 424, and a drill bit 426. The drill bit 426 may operate to create a borehole 412 by penetrating the surface 404 and subsurface formations 414. The down hole tool 424 (e.g., similar to the logging tool 302) may comprise any of a number of different types of tools including MWD tools, LWD tools, and others.

During drilling operations, the drill string 408 (perhaps including the Kelly 416, the drill pipe 418, and the bottom hole assembly 420) may be rotated by the rotary table 410. In addition to, or alternatively, the bottom hole assembly 420 may also be rotated by a motor (e.g., a mud motor) that may be located down hole. The drill collars 422 may be used to add weight to the drill bit 426. The drill collars 422 may also operate to stiffen the bottom hole assembly 420, allowing the bottom hole assembly 420 to transfer the added weight to the drill bit 426, and in turn, to assist the drill bit 426 in penetrating the surface 404 and subsurface formations 414.

During drilling operations, a mud pump 432 may pump drilling fluid (sometimes known by those of ordinary skill in the art as “drilling mud”) from a mud pit 434 through a hose 436 into the drill pipe 418 and down to the drill bit 426. The drilling fluid may flow out from the drill bit 426 and be returned to the surface 404 through an annular area 440 between the drill pipe 418 and the sides of the borehole 412. The drilling fluid may then be returned to the mud pit 434, where such fluid may be filtered. In some embodiments, the drilling fluid may be used to cool the drill bit 426, as well as to provide lubrication for the drill bit 426 during drilling operations. Additionally, the drilling fluid may be used to remove subsurface formation 414 cuttings created by operating the drill bit 426. It may be the images of these cuttings that many implementations operate to acquire and process.

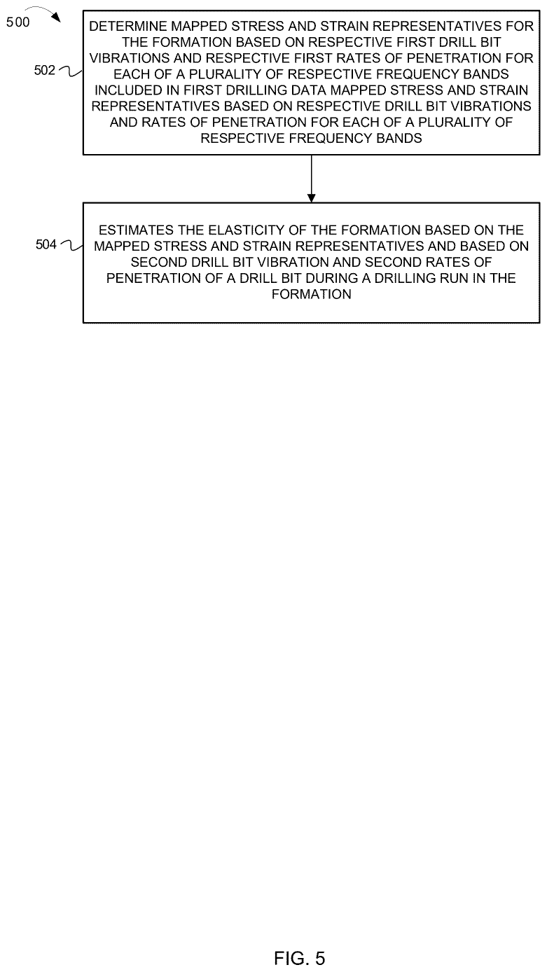

FIG. 5 is a flow diagram showing operations for determining formation elasticity, according to some implementations. At block 502, a NN determines mapped stress and strain representatives for the formation based on respective first drill bit vibrations and respective first rates of penetration for each of a plurality of respective frequency bands included in first drilling data mapped stress and strain representatives based on respective drill bit vibrations and rates of penetration for each of a plurality of respective frequency bands. At block 504, the NN estimates the elasticity of the formation based on the mapped stress and strain representatives and based on second drill bit vibration and second rates of penetration of a drill bit during a drilling run in the formation.

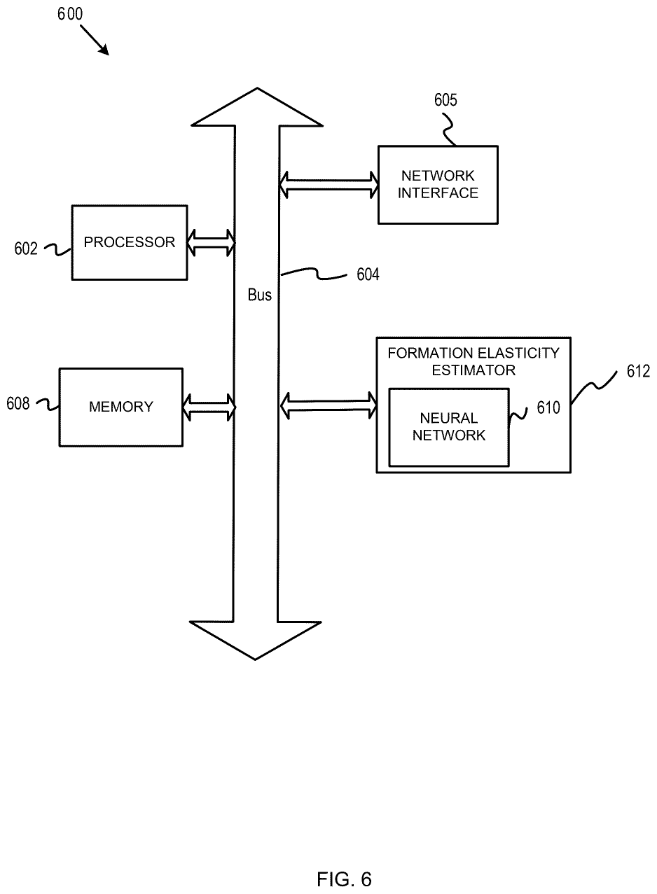

In some implementations, the plug movement detector may be integrated into a computer system. FIG. 6 is a block diagram illustrating a computer system that may be utilized with some implementations, according to some implementations. In FIG. 6, the computer system 600 may include one or more processors 602 connected to a system bus 604. The system bus 604 may be connected to memory 608 and a network interface 605. The memory 608 may include any suitable memory random access memory (RAM), non-volatile memory (e.g., magnetic memory device), and/or any device for storing information and instructions executable by the processor(s) 602. The network interface 605 may provide connectivity to any suitable network, such as a wired network, wireless network, satellite network, etc.

The computer system 600 may include additional peripheral devices. For example, the computer system 600 may include multiple external multiple processors. In some implementations, any of the components may be integrated or subdivided.

The computer system 600 also may include a formation elasticity estimator 612. The formation elasticity estimator 612 may implement the methods and operations described herein. The formation elasticity estimator 612 may include a NN 610 or other logic for performing operations described herein. The NN 610 may include any or all of the components described with reference to FIG. 1. In some implementations, the computer system 600 may be included in the system described with reference to FIGS. 3 and 4.

Although the components are shown separately, any of the components of the computer system 600 may be further combined or subdivided. Any component of the computer system 600 may be implemented as hardware, firmware, and/or machine-readable media including computer-executable instructions for performing the operations described herein. For example, some implementations include one or more non-transitory machine-readable media including computer-executable instructions including program code configured to perform functionality described herein. Machine-readable media includes any mechanism that provides (e.g., stores and/or transmits) information in a form readable by a machine (e.g., a computer system). For example, tangible machine-readable media includes read only memory (ROM), random access memory (RAM), magnetic disk storage media, optical storage media, flash memory machines, etc. Machine-readable media also includes any media suitable for transmitting software over a network.

FIGS. 1-6 and the operations described herein are examples meant to help in understanding example implementations and should not be used to limit the potential implementations or limit the scope of the claims. None of the implementations described herein may be performed exclusively in the human mind nor exclusively using pencil and paper. None of the implementations described herein may be performed without computerized components such as those described herein. Some implementations may perform additional operations, fewer operations, operations in parallel or in a different order, and some operations differently. Some implementations may perform the operations with different components.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits, and algorithm processes described in connection with the implementations disclosed herein may be implemented as electronic hardware, computer software, or combinations of both. The interchangeability of hardware and software has been described in terms of functionality, and illustrated in the various illustrative components, blocks, modules, circuits, and processes described throughout. Whether such functionality is implemented in hardware or software depends upon the particular application and design constraints imposed on the overall system.

The hardware and data processing apparatus used to implement the various illustrative logics, logical blocks, modules and circuits described in connection with the implementations disclosed herein may be implemented or performed with a general purpose single- or multi-chip processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein. A general-purpose processor may be a microprocessor or any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more implementations, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, such as one or more modules of computer program instructions stored on a computer storage media for execution by, or to control the operation of, a computing device.

If implemented in software, the functions may be stored on or transmitted over as one or more instructions or code on a computer-readable medium. The processes of a method or algorithm disclosed herein may be implemented in a processor-executable instructions which may reside on a computer-readable medium. Computer-readable media includes both computer storage media and communication media including any medium that may be enabled to transfer a computer program from one place to another. Storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-Ray™ disc where disks usually reproduce data magnetically, while discs reproduce data optically with lasers. Combinations also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example process in the form of a flow diagram. However, some operations may be omitted and/or other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described should not be understood as requiring separation in all implementations, and the described program components and systems may be integrated together in a single software product or packaged into multiple software products. Additionally, other implementations are within the scope of the following claims. In some cases, the actions recited in the claims may be performed in a different order and still achieve desirable results.

### Example Clauses

Some implementations may include the following clauses.

Clause 1: A method for estimating elasticity of a formation, comprising: determining, via a neural network, mapping parameters based on respective drill bit vibrations for each of a plurality of respective frequency bands and a rate of penetration included in drilling data; and estimating, by a physics-based model, the elasticity of the formation based on stress and strain representatives mapped via the mapping parameters from the respective drill bit vibrations and the rate of penetration of a drill bit during a drilling run in the formation.

Clause 2: The method of clause 1, further comprising: inputting into the neural network, for a selected one of the respective frequency bands, a two-dimensional probability distribution of the respective drill bit vibrations associated with the selected one of the respective frequency bands and the rate of penetration, wherein the determination of the mapping parameters for the stress and strain representatives are based on the two-dimensional probability distribution.

Clause 3: The method of any one or more of clauses 1-2, wherein each of the plurality of respective frequency bands is above a threshold frequency determined by vibration sampling frequency and drilling dysfunctions analysis.

Clause 4: The method of any one or more of clauses 1-3, wherein the elasticity of the formation is represented by Young's Modulus.

Clause 5: The method of any one or more of clauses 1-4, wherein the elasticity of the formation is represented by Poisson's ratio or anisotropy.

Clause 6: The method of any one or more of clauses 1-5, comprising: performing operations for training the neural network, the operations including inputting, into a first component of the neural network, a two-dimensional image indicating a two-dimensional probability distribution of the drilling data including a sequence of vibration values (Vibe Y/Z) and a sequence of rate of penetration (ROP) values.

Clause 7: The method of any one or more of clauses 1-6, wherein the neural network includes an input variational autoencoder (VAE) trained with drill bit vibration data and rate of penetration data from a plurality of geographic regions; and a latent space connector and an output VAE trained with drill bit vibration data, rate of penetration data, and mapping parameter data from one geographic region.

Clause 8: The method of any one or more of clauses 1-7, wherein a wellbore is formed in the formation, wherein a wellbore operation is modified based on the estimating of the elasticity of the formation.

Clause 9: The method of any one or more of clauses 1-8, further comprising: modifying a wellbore operation for a wellbore formed in the formation based on the estimating of the elasticity of the formation.

Clause 10: One or more computer-readable mediums including instructions that, when executed by one or more processors, cause one or more computers to perform operations for estimating elasticity of a formation, the instructions comprising: instructions to determine, via a neural network, mapping parameters based on respective drill bit vibrations for each of a plurality of respective frequency bands and a rate of penetration included in drilling data; and instructions to estimate, by a physics-based model, the elasticity of the formation based on stress and strain representatives mapped via the mapping parameters from the respective drill bit vibrations and the rate of penetration of a drill bit during a drilling run in the formation.

Clause 11: The one or more computer-readable mediums of clause 10, the instructions further comprising: instructions to input into the neural network, for a selected one of the respective frequency bands, a two-dimensional probability distribution of the respective drill bit vibrations associated with the selected one of the respective frequency bands and the rate of penetration, wherein the determination of the mapping parameters for the stress and strain representatives are based on the two-dimensional probability distribution.

Clause 12: The one or more computer-readable mediums of any one or more of clauses 10-11, wherein each of the plurality of respective frequency bands is above a threshold frequency determined by vibration sampling frequency and drilling dysfunctions analysis.

Clause 13: The one or more computer-readable mediums of any one or more of clauses 10-12, wherein the elasticity of the formation is represented by at least one of Young's Modulus, Poisson's ratio, or anisotropy.

Clause 14: The one or more computer-readable mediums of any one or more of clauses 10-13, the instructions further comprising: instructions to train the neural network, the operations including instructions to input, into a first component of the neural network, a two-dimensional image indicating a two-dimensional probability distribution of the drilling data including a sequence of vibration values (Vibe Y/Z) and a sequence of rate of penetration (ROP) values.

Clause 15: The one or more computer-readable mediums of any one or more of clauses 10-14, wherein the neural network includes an input variational autoencoder (VAE) trained with drill bit vibration data and rate of penetration data from a plurality of geographic regions; and a latent space connector and an output VAE trained with drill bit vibration data, rate of penetration data, and mapping parameter data from one geographic region.

Clause 16: A system comprising: one or more processors; and one or more computer-readable mediums including instructions that, when executed by one or more processors, cause one or more computers to perform operations for estimating elasticity of a formation, the instructions including instructions to determine, via a neural network, mapping parameters based on respective drill bit vibrations for each of a plurality of respective frequency bands and a rate of penetration included in drilling data, and instructions to estimate, by a physics-based model, the elasticity of the formation based on stress and strain representatives mapped via the mapping parameters from the respective drill bit vibrations and the rate of penetration of a drill bit during a drilling run in the formation.

Clause 17: The system of clause 16, the instructions further comprising: instructions to input into the neural network, for a selected one of the respective frequency bands, a two-dimensional probability distribution of the respective drill bit vibrations associated with the selected one of the respective frequency bands and the rate of penetration, wherein the determination of the mapping parameters for the stress and strain representatives are based on the two-dimensional probability distribution.

Clause 18: The system of any one or more of clauses 16-17, wherein each of the plurality of respective frequency bands is above a threshold frequency determined by vibration sampling frequency and drilling dysfunctions analysis.

Clause 19: The system of any one or more of clauses 16-18, wherein the elasticity of the formation is represented by at least one of Young's Modulus, Poisson's ratio, or anisotropy.

Clause 20: The system of any one or more of clauses 16-19, the instructions further comprising: instructions to train the neural network, the operations including instructions to input, into a first component of the neural network, a two-dimensional image indicating a two-dimensional probability distribution of the drilling data including a sequence of vibration values (Vibe Y/Z) and a sequence of rate of penetration (ROP) values.

What is claimed is:

1. A method for estimating elasticity of a formation, the method comprising:
determining, via a neural network, mapping parameters based on respective drill bit vibrations for each of a plurality of respective frequency bands and a rate of penetration included in drilling data; and
estimating, by a physics-based model, the elasticity of the formation based on stress and strain representatives mapped via the mapping parameters from the respective drill bit vibrations and the rate of penetration of a drill bit during a drilling run in the formation.

2. The method of claim 1 further comprising:
inputting into the neural network, for a selected one of the respective frequency bands, a two-dimensional probability distribution of the respective drill bit vibrations associated with the selected one of the respective frequency bands and the rate of penetration, wherein the determination of the mapping parameters for the stress and strain representatives are based on the two-dimensional probability distribution.

3. The method of claim 1, wherein each of the plurality of respective frequency bands is above a threshold frequency determined by vibration sampling frequency and drilling dysfunctions analysis.

4. The method of claim 1, wherein the elasticity of the formation is represented by Young's Modulus.

5. The method of claim 1, wherein the elasticity of the formation is represented by Poisson's ratio or anisotropy.

6. The method of claim 1 comprising:
performing operations for training the neural network, the operations including
inputting, into a first component of the neural network, a two-dimensional image indicating a two-dimensional probability distribution of the drilling data including a sequence of vibration values (Vibe Y/Z) and a sequence of rate of penetration (ROP) values.

7. The method of claim 1, wherein the neural network includes
an input variational autoencoder (VAE) trained with drill bit vibration data and rate of penetration data from a plurality of geographic regions; and
a latent space connector and an output VAE trained with drill bit vibration data, rate of penetration data, and mapping parameter data from one geographic region.

8. The method of claim 1, a wellbore is formed in the formation, wherein a wellbore operation is modified based on the estimating of the elasticity of the formation.

9. The method of claim 1, further comprising:
modifying a wellbore operation for a wellbore formed in the formation based on the estimating of the elasticity of the formation.

10. One or more computer-readable mediums including instructions that, when executed by one or more processors, cause one or more computers to perform operations for estimating elasticity of a formation, the instructions comprising:
instructions to determine, via a neural network, mapping parameters based on respective drill bit vibrations for each of a plurality of respective frequency bands and a rate of penetration included in drilling data; and
instructions to estimate, by a physics-based model, the elasticity of the formation based on stress and strain representatives mapped via the mapping parameters from the respective drill bit vibrations and the rate of penetration of a drill bit during a drilling run in the formation.

11. The one or more computer-readable mediums of claim 10, the instructions further comprising:
instructions to input into the neural network, for a selected one of the respective frequency bands, a two-dimensional probability distribution of the respective drill bit vibrations associated with the selected one of the respective frequency bands and the rate of penetration, wherein the determination of the mapping parameters for the stress and strain representatives are based on the two-dimensional probability distribution.

12. The one or more computer-readable mediums of claim 10, wherein each of the plurality of respective frequency bands is above a threshold frequency determined by vibration sampling frequency and drilling dysfunctions analysis.

13. The one or more computer-readable mediums of claim 10, wherein the elasticity of the formation is represented by at least one of Young's Modulus, Poisson's ratio, or anisotropy.

14. The one or more computer-readable mediums of claim 10, the instructions further comprising:
instructions to train the neural network, the operations including
instructions to input, into a first component of the neural network, a two-dimensional image indicating a two-dimensional probability distribution of the drilling data including a sequence of vibration values (Vibe Y/Z) and a sequence of rate of penetration (ROP) values.

15. The one or more computer-readable mediums of claim 10, wherein the neural network includes
an input variational autoencoder (VAE) trained with drill bit vibration data and rate of penetration data from a plurality of geographic regions; and
a latent space connector and an output VAE trained with drill bit vibration data, rate of penetration data, and mapping parameter data from one geographic region.

16. A system comprising:
one or more processors; and
one or more computer-readable mediums including instructions that, when executed by one or more processors, cause one or more computers to perform operations for estimating elasticity of a formation, the instructions including
instructions to determine, via a neural network, mapping parameters based on respective drill bit vibrations for each of a plurality of respective frequency bands and a rate of penetration included in drilling data, and
instructions to estimate, by a physics-based model, the elasticity of the formation based on stress and strain representatives mapped via the mapping parameters from the respective drill bit vibrations and the rate of penetration of a drill bit during a drilling run in the formation.

17. The system of claim 16, the instructions further comprising:
instructions to input into the neural network, for a selected one of the respective frequency bands, a two-dimensional probability distribution of the respective drill bit vibrations associated with the selected one of the respective frequency bands and the rate of penetration, wherein the determination of the mapping parameters for the stress and strain representatives are based on the two-dimensional probability distribution.

18. The system of claim 16, wherein each of the plurality of respective frequency bands is above a threshold frequency determined by vibration sampling frequency and drilling dysfunctions analysis.

19. The system of claim 16, wherein the elasticity of the formation is represented by at least one of Young's Modulus, Poisson's ratio, or anisotropy.

20. The system of claim 16, the instructions further comprising:
instructions to train the neural network, the operations including
instructions to input, into a first component of the neural network, a two-dimensional image indicating a two-dimensional probability distribution of the drilling data including a sequence of vibration values (Vibe Y/Z) and a sequence of rate of penetration (ROP) values.
